(19) United States
(12) Patent Application Publication
(10) Pub. No.: US 2016/0026720 A1
(43) Pub. Date: Jan. 28, 2016

(54) SYSTEM AND METHOD FOR PROVIDING A SEMI-AUTOMATED RESEARCH TOOL

(71) Applicants: David LEHRER, Jackson Heights,, NY (US); Uwe DICK, Berlin (DE); Michael BRUECKNER, Berlin (DE); CONATIX EUROPE UG, Berlin (DE)

(72) Inventors: David Lehrer, Berlin (DE); Uwe Dick, Berlin (DE); Michael Brueckner, Berlin (DE)

(73) Assignee: Conatix Europe UG, Berlin (DE)

(21) Appl. No.: 14/777,277

(22) PCT Filed: Mar. 14, 2014
(86) PCT No.: PCT/US2014/029461

§ 371 Date: Sep. 15, 2015

Related U.S. Application Data
(60) Provisional application No. 61/801,799, filed on Mar. 15, 2013.

(51) Int. Cl. G06F 17/30

(52) U.S. Cl. CPC G06F 17/30867; G06F 17/30598; G06F 17/30345

(57) ABSTRACT

A system and method for providing a project-based research tool is provided. The system may create, update, and/or manage a project and/or content related to the project. The project may be updated based on an iterative process of identifying and/or obtaining content from various content sources, determining the relevance of the content to the project based on relevance determination models, providing recommended content based on the relevance, obtaining user interaction data by monitoring user interaction with the recommended content, and/or training the relevance determination models based on the user interaction data. The system may create and/or modify the relevance determination models based on the user interaction data. The system may update in real-time or near real-time the recommended content as a user of the project interacts with the recommended content and/or with other content.

### CROSS-REFERENCE TO RELATED APPLICATIONS

This application claims the benefit of U.S. Provisional Patent Application Ser. No. 61/801,799, entitled “SYSTEM AND METHOD FOR PROVIDING A SEMI-AUTOMATED RESEARCH TOOL,” filed Mar. 15, 2013, the contents of which are hereby incorporated by reference in their entirety.

### FIELD OF THE INVENTION

The invention relates to systems and methods for providing a semi-automatic research tool including the ability to create, update, and/or manage a research project and/or content related to the research project.

### BACKGROUND OF THE INVENTION

The Internet contains a vast amount of information and serves as a great tool for research and other forms of collection and curation of topically related content. Searching for relevant information from the large amounts of information available, however, presents difficult challenges for many research organizations. For a complicated research topic, the research may be performed by a team of researchers who can collaboratively work together to produce collective research products. However, various limitations exist with respect to how a team-based research project can be effectively created and/or managed to improve the quality of the research products.

In many instances, even when individual researchers review identical information, they may classify it differently. These inconsistencies are not uncommon when human judgment is involved.

Thus, what is needed is to be capable of creating and managing a team-based research project that produces more consistent research products. These and other problems exist.

### SUMMARY OF THE INVENTION

The invention relates to systems and methods for providing a project-based research tool. Another aspect of the invention relates to creating, updating, and/or managing a project and/or content related to the project. Another aspect of the invention relates to iteratively updating the project. For example, the project may be updated based on an iterative process of identifying and/or obtaining content from various content sources, determining the relevance of the content to the project based on one or more relevance determination models, providing recommended content based on the relevance, obtaining user interaction data by monitoring user interaction with the recommended content, and/or training the one or more relevance determination models based on the user interaction data. Another aspect of the invention relates to identifying and/or obtaining content from various content sources based on seed content. The seed content may comprise, for example, a list of Universal Resource Locators (URLs), the user interaction data, the recommended content, and/or other content.

Another aspect of the invention relates to creating and/or modifying the one or more relevance determination models based on the user interaction data and/or aggregated user interaction data of one or more users that form a project team.

Another aspect of the invention relates to generating a list of recommended content items (“recommended content list”) based on the determined relevance of the content to the project. Another aspect of the invention relates to updating in real-time or near real-time the recommended content list as one or more users of the project team interact with one or more content items within the list and/or other content items.

Another aspect of the invention relates to generating a report related to the project (e.g., a research report) by aggregating annotations, comments, and/or other notes provided by one or more users of the project team.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system of providing a semi-automated research tool, according to an aspect of the invention.

FIG. 2 illustrates a data flow diagram for creating a new project and iteratively updating the project, according to an aspect of the invention.

FIG. 3 illustrates a process of crawling for content based on seed content, according to an aspect of the invention.

FIG. 4 illustrates a process of training one or more relevance determination models based on an interaction profile, according to an aspect of the invention.

FIG. 5 illustrates a process of updating a recommended content list in real-time as a user interacts with content, according to an aspect of the invention.

FIG. 6 illustrates a data structure in which an exemplary mapping between a user and one or more projects is shown, according to an aspect of the invention.

FIG. 7 illustrates a screenshot of an interface for managing a recommended content list, according to an aspect of the invention.

FIG. 8 illustrates a screenshot of an interface for managing a user content list, according to an aspect of the invention.

FIG. 9 illustrates a screenshot of an interface for generating a report, according to an aspect of the invention.

### DETAILED DESCRIPTION OF THE INVENTION

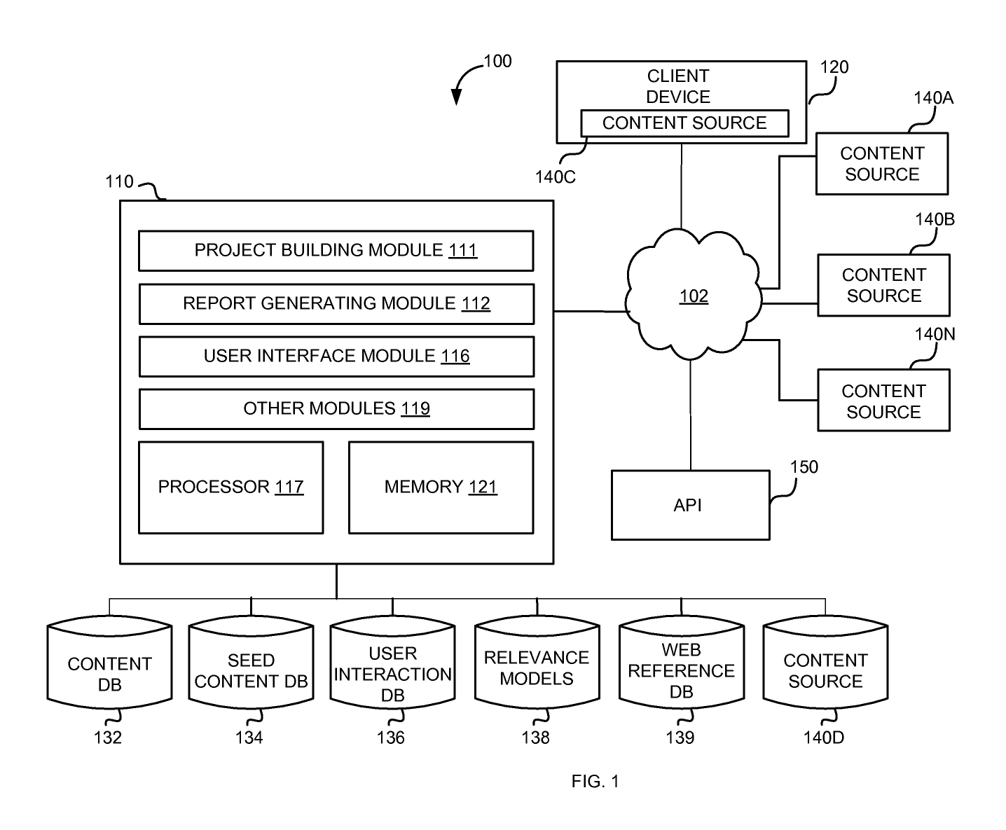

FIG. 1 illustrates a system 100 of providing a semi-automated research tool, according to an aspect of the invention.

As used herein, content may comprise webpages (e.g., HTML, XHTML, etc.) and/or other document content (e.g., Adobe Acrobat documents (PDF), Microsoft Office files (Word, Excel, PowerPoint, Visio, etc.), Open Office documents, etc.), email content, multi-media content (e.g., images, video, audio, etc.), news feeds and ticker (e.g., RSS/XML), social media content, content from Customer Relationship Management (CRM) databases (e.g., customer contacts), content from Linked Web of Data, content from proprietary/closed sources (e.g., Westlaw content, Financial Times articles, Pinterest, Evernote, other web clipping tools, etc.), deep web content (requiring a login/password to sign in to access, e.g., U.S. Census database, other online government databases, etc.), and/or other content. The content may include unstructured and/or structured data.

As used herein, a project may represent and/or may be related to a topic, a sub-topic, a combination of a plurality of topics, and/or a combination of a plurality of sub-topics. A topic may comprise one or more sub-topics within the topic. A sub-topic may also comprise one or more additional sub-topics within the sub-topic. A topic and/or sub-topic may indicate a subject, category, subject matter area, theme, and/or other classification group.

A user may be associated with one or more projects. For example, the user may be assigned to a research project about “Topic 1” and another research project about a different topic, “Sub-Topic 2.1.” For example, when a plurality of users is assigned to a given project, the plurality of users may be referred to as a “project team.” In this manner, the project may provide a collaborative workspace where the members of the project team may share content and/or communicate and interact with each other while conducting research. In another example, the project team may be composed of just a single user.

The project may comprise one or more content items related to the corresponding topic and/or sub-topic. A content item may be associated with and/or belong to a single project and/or a plurality of projects. The project may provide a dedicated workspace for individual users of the project team to keep track of a list of their own research results (hereinafter, “user content list”). A user may add content to the user content list by, for example, actively interacting with (e.g., by adding tags, bookmarks, annotations, comments, and/or notes to the content) one or more content items from a recommended content list (e.g., content recommended by the system based on one or more relevance determination models) that has been presented to the user. In another example, the user may add content to the user content list by actively interacting with content from user-initiated searches (e.g., webpages that the user visited while performing searches via a search engine). In this example, while the user is performing searches using Internet, Intranet, Extranet, social media (e.g., Facebook, Twitter, etc.), professional networks (e.g., LinkedIn, Xing, etc.), and/or other content sources, various user activities, behaviors, and/or other user interactions (e.g., webpages and/or documents the user visited, tagged, bookmarked, annotated, commented, etc.) may be monitored, logged, and/or sent to the system for analysis. Based on the monitored user interaction data, the system may identify those content items the user actively interacted with and/or add the items to the user content list. In another example, the user may add content to the user content list by uploading, importing, or otherwise providing the content the user believes to be relevant to the project. This type of content may be referred to as “user-provided content.” For example, when the user gets tasked to a research project, his team lead may email him several PDF documents which include a general description of the research topic. The user may upload these documents to the system and they may be automatically added to the user content list.

In some embodiments, a project may be associated with one or more project attributes: project identification (“ID”), one or more topics and/or sub-topics associated with the project, title of the project, summary, description, notes, date/time information (e.g., project start date, end date, completion date, etc.), project status (e.g., not yet started, in progress, completed, etc.), identification of a project team lead, and/or other attributes related to the project. The one or more project attributes may be system-generated and/or generated based on user input. For example, the one or more topics associated with the project may be automatically generated based on various classification, categorization and/or clustering techniques, as discussed herein. In another example, a user may specify one or more tags, keywords, and/or other information that may indicate one or more topics related to the project. In some embodiments, a user may be associated with one or more user attributes: user ID, user name, title, office phone, cell phone, address, and/or other information related to the user.

System 100 may include a computer 110, a client device 120, and/or other components. In some embodiments, computer 110 may include one or more processors 117 configured to perform some or all of a functionality of a plurality of modules, which may be stored in a memory 121. For example, the one or more processors 117 may be configured to execute a project building module 111, a report generation module 112, a user interface module 116, and/or other module 119.

Project building module 111 may be configured to create a new project and/or update an existing project. The new project may be created by the system and/or a user. In some embodiments, the new project may be created by the system by classifying, categorizing, and/or clustering a plurality of content items based on textual, structural, and/or contextual features and/or other features related to the content items. Various classification, categorization, and/or clustering techniques may be used, as apparent to those skilled in the art. Project building module 111 may automatically assign a particular cluster, category, and/or group of content items to an existing project based on analyzing content, content attributes, project, and/or project attributes. For a cluster, category, and/or group of content items which do not match with an existing project may be assigned to a new project. In this way, project building module 111 may efficiently identify new projects while completing information on existing projects. In other embodiments, the new project may be created based on user input. For example, a user may log into the system and create a new project by specifying a title and/or one or more topics related to the project, specifying a team lead for the project, selecting one or more users as members of the project team, etc. The project, once created, may then be updated through an iterative process of identifying and/or obtaining content items relevant to the project.

Project building module 111 may be configured to manage the project and/or content related to the project. In some embodiments, project building module 111 may modify and/or update one or more project attributes related to the project. For example, one or more project team members may be removed from and/or newly added to the project. In another example, project building module may remove one or more content items from the project and/or add one or more new content items to the project (e.g., by uploading user-provided content).

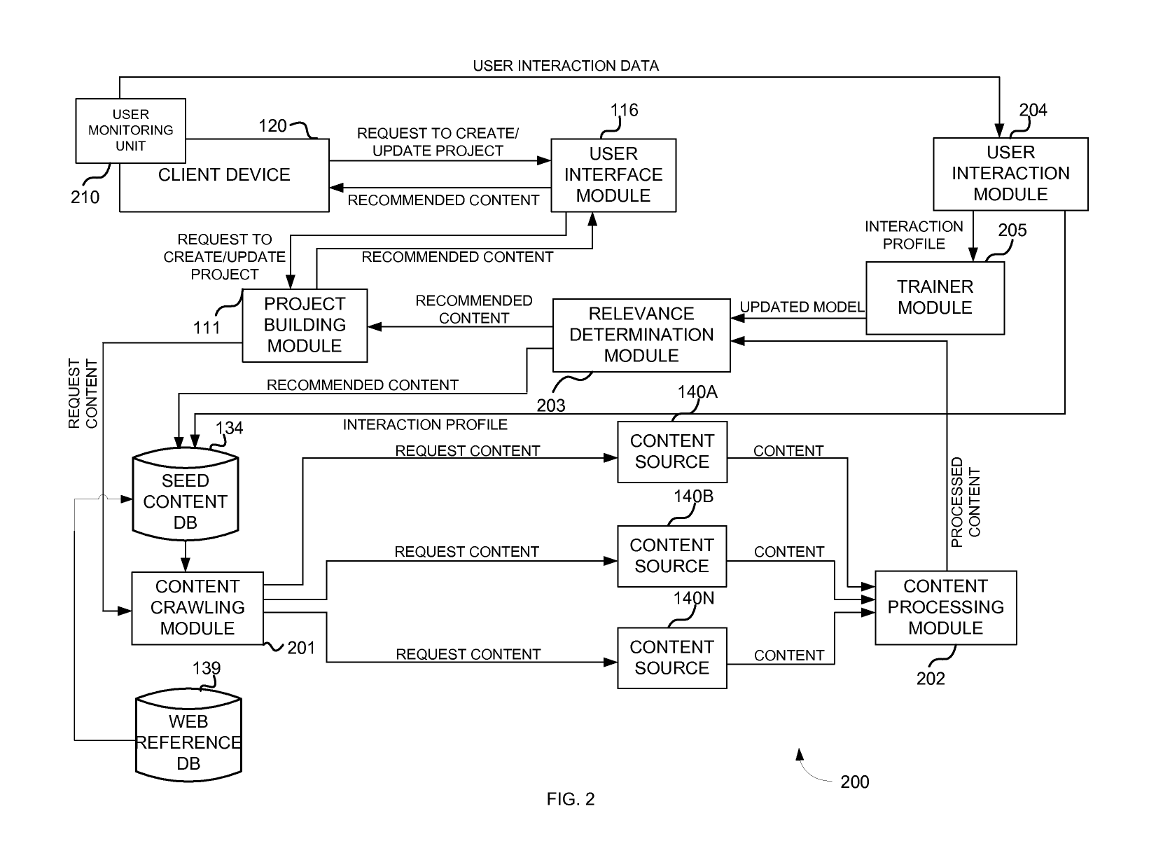

Project building module 111 may include sub-modules that are used to create a new project and/or update an existing project. The sub-modules may identify and/or obtain content from various content sources (illustrated as a content source 140A, 140B, 140C, 140D, . . . , 140N), determine relevance of the obtained content to the project based on one or more relevance determination models, provide recommended content based on the relevance, obtain user interaction data by monitoring user interaction with the recommended content, and/or updating the one or more relevance determination models based on the user interaction data. The one or more relevance determination models may be updated when a user interacts with existing documents, for example. Adding, removing, and/or updating documents may be considered as user interaction. For example, the sub-modules may include a content crawling module, a content processing module, a relevance determination module, a user interaction module, and/or trainer module, as discussed below with respect to FIG. 2.

Report generating module 112 may be configured to generate a report by aggregating notes including notes created and/or added by a user and/or notes created by one or more teammates of the user, providing an easy way to make a comprehensive report about the research topic. As used herein, the notes may comprise comments, annotations, highlighted content, portions of content that have been copied and pasted, etc. In some embodiments, report generation module 112 may automatically generate and/or attach relevant citations to the notes. In some embodiments, the user via report generation module 112 may arrange the notes in a desired order and/or generate a draft of the report with the notes arranged in that order.

An application programming interface (“API”) 150 may be configured to enable communication between various components of system 100. API 150 may receive a request from any of the system components, analyzes the request and/or handles the request by calling an appropriate handler. For example, a content handler may process requests to make changes in content database 132 and/or retrieve content from content database 132 based on the type of the request and/or the query form. For example, the content handler may be used to retrieve information about organizations, users within the organizations, projects related to users, and/or users' content list. In another example, a user interaction handler may receive user interaction data which may include information about visited webpages, opened documents, tags, bookmarks, annotations, comments, and/or notes. The user interaction handler may analyze and/or store the user interaction data in user interaction database 136 under the project, user, and/or organization that the content may be associated with. In another example, a login/logout handler may handle a user's request to log in and/or log out of the system. For example, the login/logout handler may generate a user token associated with the user. API 150 may check the authentication of the user based on the user token.

In some embodiments, user interface module 116 may be configured to generate user interfaces that allow interaction with the project and/or content therein. For example, user interface module 116 may present various displays for communicating a recommended content list and/or a user content list, and/or generating a report. A user may, via user interface module 116, view, add, delete, update, share, or otherwise interact with the content presented to the user using, for example, client device 120. In some embodiments, recommended content lists, user content lists, reports, and other content may be communicated, provided, and/or delivered via email, RSS (Really Simple Syndication) feed, SMS (Short Message Service), SaaS (Software as a Service), an integrated or resident software application, a proprietary medium, and/or other media.

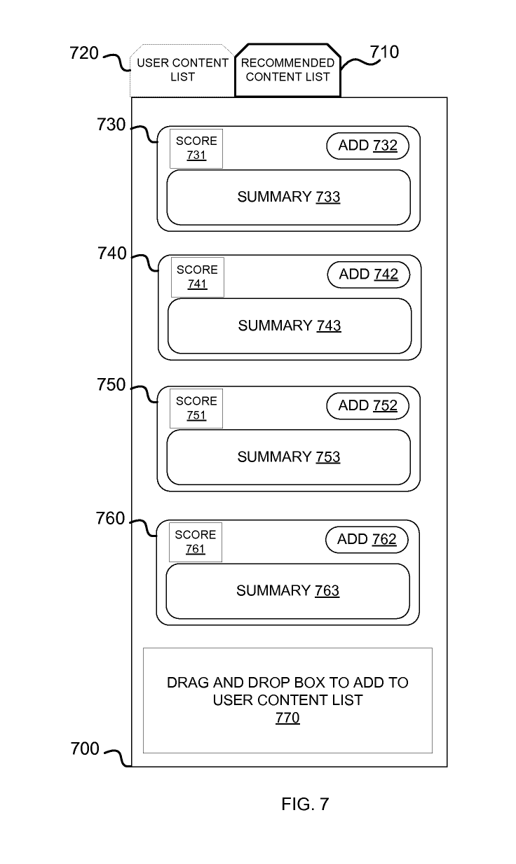

Exemplary screenshots of interfaces generated by user interface module 116 are illustrated in FIGS. 7-9.

Those having skill in the art will recognize that computer 110 and client device 120 may each comprise one or more processors, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data that may be manipulated by the processor. The storage devices may comprise floppy disks, hard disks, optical disks, tapes, or other storage devices for storing computer-executable instructions and/or data.

One or more applications, including various modules, may be loaded into memory and run on an operating system of computer 110 and/or client device 120. In one implementation, computer 110 and client device 120 may each comprise a server device, a desktop computer, a laptop, a cell phone, a smart phone, a mobile device, a Personal Digital Assistant, a pocket PC, a tablet PC, wearable Google glasses, and/or other device.

Network 102 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

Having provided a non-limiting overview of exemplary system architecture 100, the various features and functions enabled by computer 110 will now be explained.

FIG. 2 illustrates a data flow diagram 200 for creating a new project and iteratively updating the project, according to an aspect of the invention. Through various modules, project building module 111 may create a new project and iteratively update the project based on one or more user-based interaction profiles generated based on monitoring user interaction with project content. For example, project building module 111 may include or otherwise access a content crawling module 201, a content processing module 202, a relevance determination module 203, a user interaction module 204, and/or a trainer module 205.

Project building module 111 may be configured to communicate a user interface via user interface module 116. The user interface may include a web page, an application executing on a mobile device, and/or other interface that can receive input and/or communicate outputs. Although not illustrated in FIG. 2, project building module 111 may expose an interface that allows application programs to communicate requests and/or receive outputs from project building module 111. Client device 120 may display a user interface provided by user interface module 116, which a user may use to create, update, manage, view and/or interact with a project and/or content related to the project.

In some embodiments, project building module 111 may receive a request to create and/or update the project from client device 120 via user interface module 116. In some embodiments, process building module 111 may use content crawling module 201 to identify, fetch, and/or obtain content items from various content sources (illustrated as content source 140A, 140B, 140C, 140D, . . . , 140N). Content sources may include local (e.g., local hard drive) and/or remote networked sources that may be accessed via Internet, Intranet, Extranet, social media (e.g., Facebook, Twitter, social graph data derived from user activity on social media, etc.), professional networks (e.g., LinkedIn, Xing, etc.), email servers, CRM databases (e.g., customer contacts), linked web of data, proprietary/closed sources (e.g., Westlaw content, Financial Times articles, Pinterest, Evernote, other web clipping tools, etc.), deep web content (requiring a login/password to sign in to access, e.g., U.S. Census database, other online government databases, etc.), lists of URLs (e.g., in an Excel or CSV file), RSS feeds, various content providers, services, and/or publishers, and/or other sources. The seed content may include content from similar content sources as indicated above. The content retrieved from various content sources may include unstructured or structured data, which may be processed and properly formatted, for example, by content processing module 202.

Content crawling module 201 may utilize various crawling techniques, as apparent to those skilled in the art. Those crawling techniques may include, for example, web-crawling (also known as wide crawling) and focused-crawling (also known topical or vertical crawling). A web-crawler may browse the World Wide Web based on a list of sample Universal Resource Locators (URLs) where the list may be developed by performing random sampling of URLs that can be found on the Web. Focused-crawling may collect web pages that may satisfy a set of criteria and/or a search query.

In some embodiments, content crawling module 201 may use seed content that may include information specific to a project, which may be used to search for content that shows similarity and/or relevance to the project-specific information. Crawling based on the project-specific seed content may improve the quality of content obtained by content crawling module 202. For example, when content crawling module 201 receives the request to create a new project, content crawling module 201 may initially use the list of sample URLs which may be stored in a seed content database 134. Based on the initial list of sample URLs, content crawling module 201 may request content from one or more content sources in which the URLs may be located. Through an iterative and/or continuous crawling process, content crawling module 201 may identify and/or obtain project-specific seed content such as content from a database for web reference (e.g., a web reference database 139 which may include the reference for the majority of the web if URLs from this database are crawled in a certain depth), a recommended content list (e.g., top N content items from the list), user interaction data (e.g., content in user content lists, user-provided content, e.g., a briefing document written by a user about the research project, and/or other user interaction data as discussed herein), and/or other content related to the project. The seed content may also include user-specific content such as emails, files, and/or other content that are stored in or otherwise interacted with by a particular user through the user's machine (e.g., computer). In one example, the user opens an email that is stored in an external email server (e.g., Gmail, Yahoo! mail, etc.) while working on the user's computer, and that email content may be also captured and added to the seed content.

In one example, in situations where a user and/or users are not actively using and/or interacting with the system (e.g., the user went to bed at night) and/or the number of recommended content items and/or content items in the user interaction data is insufficient to generate enough seeds for seed content database 134, the rest of seed content may be supplemented by seed content from web reference database 139. This feature enables content crawler module 201 to run continuously and/or indefinitely.

The newly obtained project-specific seeds may be added to and/or stored in seed content database 134. In some embodiments, after each iteration of crawling, content crawling module 201 may determine and/or select one or more seeds to use for the next iteration from seeds stored in seed content database 134. In some embodiments, content crawling module 201 may operate independently without user intervention, which may provide the opportunity to collect content even when the user is not actively performing the research using the system.

In some embodiments, content processing module 202 may receive content identified and/or obtained by content crawling module 201 and/or process the content such that the content may be normalized into a format that is compatible with the system. Content may be syntactically normalized into an XHTML document, for example (or any portable format such as PDF, XPS or image formats). In some embodiments, content processing module 202 may analyze the normalized content, which may be partitioned into textual content and/or links (e.g., hyperlinks) appearing in the textual content. The processed content may be stored in content database 132.

In some embodiments, relevance determination module 203 may be configured to receive the processed content and/or determine relevance of the content to the project based on one or more relevance determination models. The one or more relevance determination models may be generated using various classification algorithms and/or machine learning algorithms, as apparent to those skilled in the art. For example, a classification algorithm such as a support vector machine classifier (SVM) may be used to categorize and/or classify the seed content in seed content database 134, content obtained by content crawling module 201 and/or user-provided content into one or more categories. The one or more categories used for the classification may be predetermined by the system and/or specified by a user. Textual content, structural factors (e.g., the structure of the text, the number and placement of photos or images, etc.), and/or metadata (e.g., a country the website is hosted in, website update history by the website owner, in-links and out-links, etc.) may be used for classification. In some embodiments, the one or more categories may correspond to one or more tags (e.g., keywords) that are associated with a particular project. For example, a user may specify a number of tags that may be related to the research topic. Relevance determination module 203 may use these tags to classify the content and/or calculate a relevance score that may indicate how relevant each content item is to one or more of these tags. In some embodiments, relevance determination module 203 may rank the individual content items by the relevance score assigned for each content item and/or generate a recommended content list based on the ranking. In some embodiments, content items of the recommended content list may be sorted in order of relevance score. In some embodiments, the recommended content list may include the top N content items determined based on the ranking. For example, the relevance score assigned for each content item may be compared to a predetermined threshold (e.g., system generated and/or user-specified). The recommended content list may include content items that are associated with relevance scores above (and/or equal to) the threshold and/or exclude content items that are associated with relevance scores below (and/or equal to) the threshold.

In some embodiments, the type of content items and/or the type of content sources (e.g., news sites, blogs, social media sites, etc.) which provided the content items may be used to influence the ranking and/or relevance determination (e.g., relevance scores). Certain content source types may be weighted differently than other source types based on reliability and/or credibility of the sources and/or their relevance to a particular user and/or project. In one example, relevance determination module 203 may rank content items received from news sites higher (or differently) than those received from other sources. In another example, a sales contact from a CRM database may not be weighted as highly as documents that a user has bookmarked online or a briefing about the research project that the user's manager has written and uploaded to the system. A different weight can be assigned to the same type of content source depending on the project and/or the user.

Credibility/reliability of content, types of content, and/or types of content sources may be automatically determined by the system based on, for example, user ratings, special algorithms (e.g., determining the popularity of websites by analyzing site traffic), and/or other criteria. The user ratings may be given to particular content, content type, type of content source and/or may be collected and/or aggregated over time. Credibility may be manually set by individual users and/or by the accumulated feedback of multiple users, a team, or multiple teams. For example, some news sites are considered more credible than others, but also all or nearly all news sites are considered more credible than blogs.

The weighting may be automatically determined by the system based on factors such as context and/or metadata associated with a particular source type, and/or manually assigned by a user. For example, the data provided by the popularity or influence of a specific source (e.g., how many times a source is mentioned, liked, and/or forwarded in social media or other online communities) may be used as one of several factors to determine the weighting.

In some embodiments, the ranking and/or relevance determination (e.g., relevance score) may be influenced by one or more attributes associated with individual users. For example, if a more highly rated user (e.g., more credible/reliable user) thinks a document is relevant to the topic or the project, the relevancy of this document may be considered higher than another document rated as relevant by a lower-rated user. In another example, the interaction of a senior researcher may be weighted higher than other junior researchers when determining the relevance. Within a project or topic, feedback from one or more users may be weighted more highly than feedback from other users in training the relevance determination model. For example, one user may have more clout (influence, importance, popularity, expertise, level of activity within the system or in other social media applications) than others in general or with respect to a specific topic.

In some embodiments, there may be different relevance determination models created for each user-project combination and/or for each project. In these embodiments, a single user may be assigned one or more different relevance determination models. For example, User A may create a research project about Topic A that may include User B and User C. Relevance determination module 203 may determine relevance of content items found for User A based on a relevance determination model that may be selected from a number of different models that may be stored in a relevance models database 138 for User A. In one example, the relevance may be determined based on one or more relevance determination models that were created and/or updated based on a user-based interaction profile associated with User A (e.g., user interaction data generated by User A while researching on Topic A). In another example, the relevance may be determined based on one or more relevance determination models that were created and/or updated based on a team-based interaction profile associated with User A (e.g., user interaction data generated by User A, User B, and User C while researching on Topic A).

In some embodiments, relevance determination module 203 may provide a real-time relevance determination of a content item that a user accesses during user-initiated searches. In addition to the content items obtained by content crawling module 201 and/or automatically recommended by relevance determination module 203, a user may also perform searches using Internet, Intranet, Extranet, social media (e.g., Facebook, Twitter, etc.), professional networks (e.g., LinkedIn, Xing, etc.), and/or other content sources. For example, the user may visit a new webpage while the user is performing searches using a search engine (e.g., Google, Yahoo, Bing, etc.). Relevance determination module 203 may instantaneously calculate the relevance score for this particular webpage based on a relevance determination model and/or send the score via user interface module 116. As the user opens the webpage, the user may immediately see the relevance score and/or an indicator whose color reflects the level of relevance (e.g., Green for very likely to be relevant to the topic currently being researched, Yellow for not likely to be relevant or irrelevant, Red for very unlikely to be relevant, etc.), which may be displayed with the webpage. The relevance score or any indicator of the score may be represented as a static score or a continuously changing score as the given content item is re-scored in relation to content items that are newly discovered by crawling module 201. This gives an instant relevance assessment of new user-visited webpages. That way, even when surfing around the web, the user can decide whether or not to bookmark pages by seeing how relevance determination module 203 rates the relevance of that page to the user's topic.

Client device 120 may include a user monitoring unit 210 which may monitor and/or observe user activities, behaviors, and/or other user interactions including which content item a user accesses (e.g., visits a webpage, opens a document, etc.), which content item the user views, adds, deletes, updates, shares, and/or adds tags, bookmarks, annotations, comments, and/or notes to, the amount of time spent by the user per piece of content or source (e.g., reading it or keeping it open in active screen view on the user device), and/or other user interactions. For example, in addition to reviewing the content recommended by the system, a user may also perform user-initiated searches using a search engine (e.g., Yahoo, Google, Bing, etc.). In addition to implicit (behavioral and contextual) user feedback (e.g., adding tags, bookmarking, annotating, etc.), the user interaction data may include explicit user feedback. Explicit use feedback may be provided by indicating a degree of relevance via, for example, a Relevance Slider (from Low to High relevance), via a Star system (1 to 5 Stars), via a binary Like/Dislike button, and/or other methods.

In some embodiments, project building module 111 may include user interaction module 204 which may obtain the user interaction data from user monitoring unit 210 and/or user interaction database 136 (illustrated in FIG. 1). User interaction module 204 may analyze the user interaction data to identify types of content the user considers to be relevant and/or irrelevant. For example, as the user visits webpages and documents and provides positive signals by tagging, bookmarking, adding annotations, comments, and/or notes, the system may gain a better understanding of what the particular user is seeking to discover for the research project. The system may learn from these user behaviors and/or continuously improve the performance of the system. In some embodiments, the user interaction data may include information related to the user's interactions with the recommended content list. For example, the user may select a content item from the recommended content list and/or add to the user content list by manually adding the content item to the user content list and/or by adding tags, bookmarks, annotations, comments, and/or notes to the content item from the recommended content list.

In some embodiments, the user-interaction data may include content (and/or an identification of content) that may be classified into at least two categories of content: positive content and negative content. The classification may be based on, for example, the degree of user interaction with particular content. For example, the positive content may comprise content that a user actively interacted with (e.g., by adding tags, bookmarks, annotations, comments, and/or notes to the content or simply by reading it or keeping it open in active screen view on the user device) while the user is reviewing content from user-initiated searches. The rationale is that if the user spent time to read, tag, bookmark, annotate, make comments and/or notes on the content, then it may be highly likely that the user considered the content to be relevant to the project. In some embodiments, the positive content identified in this way may be automatically added to a user content list associated with the user. Moreover, the amount of time spent by the user per piece of content or source may itself be an indicator of the degree of relevance of that content to the user topic.

The positive content may also include content items that have been added to the user content list from the recommended content list. The user may manually add a recommended content item to the user content list by, for example, pressing an “Add” button or dragging and dropping the content item onto the user content list. The user may also add tags, bookmarks, annotations, comments, and/or notes to a particular recommended content item, which may automatically remove that content item from the recommended content list and add the item to the user content list. As such, all (or part) of the content included in the user content list may be considered as positive content, which may be stored in user interaction database 136.

The positive content may also include content items that have been explicitly indicated by the user as relevant. The user may rate a document by indicating a degree of relevance of that particular document to the research topic via, for example, a Relevance Slider (from Low to High relevance), via a Star system (1 to 5 Stars), via a binary Like/Dislike button, and/or other methods.

The negative content, on the other hand, may comprise the rest of content in the recommended content list and/or content from user-initiated searches that the user did not interact with, only passively interacted with (e.g., opening/closing a webpage), or otherwise did not add to the user content list. In one example, negative content may include the entire set of content in the recommended content list and content from user-initiated searches that excludes the positive content: ((content in the recommended content list+content from user-initiated searches)+(positive content)).

The degree of user interaction required for content to be classified as positive content may be predetermined by the system and/or may be set and/or updated based on user input. For example, a user may specify one or more user activities and/or interaction patterns that may indicate positive signals such as adding tags, bookmarks, annotations, comments, and/or notes. When the user interaction data observed for a particular content item does not correspond to one or more of the user activities and/or interaction patterns which indicate positive signals, that content item may be considered as negative content. The negative content may be stored in user interaction database 136.

In some embodiments, the user-interaction data may include content (and/or an identification of content) that may be classified into another category of content: neutral content. For example, by clicking on an “Ignore” button while reviewing a particular document, the user can indicate that the document is not relevant or irrelevant, but neutral. As such, when the user is unsure about relevancy, the “Ignore” button provides a convenient solution. For example, if a user is surfing the web and is in a domain that is generally related to his research topic, instead of bookmarking every single page, the user can simply “ignore” the pages that are not as relevant as the other pages.

In some embodiments, the user interaction data may include duration information (e.g., residence time or dwell time spent by a user on a given content item) related to user interactions. For example, the duration information may indicate the amount of time that a user spends on a particular website or reading a particular document. The duration information may be defined by an exact amount (e.g., 12 minutes 45 sections), a time period (e.g., 10-15 minutes), and/or discrete chunks of time (e.g., less than 1 minute, more than 1 minutes, more than 10 minutes, etc.). The duration information may be used as one of several factors in determining a degree of user interaction with particular content and in turn influencing the relevancy level of the content to the project. The factors may be weighted the same or differently for different users.

In some embodiments, the user interaction data may include implicit behavioral feedback by users such as eye movements and other physiological or neurological responses (e.g., relative level of activity in attention centers in the brain in order to gauge how the user is responding to specific content). Such user behavioral information may be used as one of several factors in determining a degree of user interaction with particular content and in turn influencing the relevancy level of the content to the project. The factors may be weighted the same or differently for different users.

In some embodiments, the user interaction data (including information related to the positive content and the negative content) that may be stored in user interaction database 136 may be used as a new set of crawl seeds for content crawling module 201, as discussed herein with respect to content crawling module 201. In some embodiments, the user interaction data may be used by trainer module 205 to update one or more existing relevance determination models. The models may be iteratively refined such that more relevant content may be retrieved and/or recommended by the system over time. In some embodiments, content crawling module 201 and relevance determination module 203 may run simultaneously such that relevance determination models may be constantly updated based on the user interaction data even in the middle of a crawl iteration.

In some embodiments, the user interaction data generated by a user while researching for a project may be associated with a particular user-project combination. The user interaction data associated with the particular user-project combination may be referred to as a user-based interaction profile. In some embodiments, the user interaction data generated by one or more project teammates may be combined with the user-based interaction profile to create a team-based interaction profile. The team-based interaction profile may be created for a subset of the team and/or the entire team. For example, User A, User B, and User C may belong to the same project. In this example, a team-based interaction profile may be created for User A and User B by combining the user-based interaction profiles of User A and B. Another team-based interaction profile may be created for the entire team by combining the user-based interaction profiles of User A, User B, and User C.

In some embodiments, trainer module 205 may use any one or more of the user-based interaction profile and/or team-based interaction profile to update the user's relevance determination model. Thus, when the team-based interaction profile is used, the recommended content list presented to the user may be determined based on not only what the user is doing for the research project but also based on what the one or more teammates are doing for that same project. This provides the opportunity to work collaboratively with other teammates within the project and produce better research results at the end. In some embodiments, content crawler module 201 may use the user-based interaction profile and/or team-based interaction profile to crawl for additional content from content sources.

In some embodiments, trainer module 205 may be configured to determine an interaction profile to be used to train and/or update one or more relevance determination models associated with a particular user-project combination. In some embodiments, a user may select and/or specify a particular interaction profile for one or more relevance determination models associated with the user for a particular project. For example, the user may be aware of the fact that one of her teammates is a skilled researcher. The user may specify via trainer module 205 that a team-based profile that is created based on the user-based profile of that teammate should be used to update the one or more relevance determination models. In some embodiments, the user may also specify an interaction profile to be used to crawl for additional content from content sources. In some embodiments, the interaction profile to be used by content crawling module 201 and/or trainer module 205 may be automatically determined by the system.

In some embodiments, content crawling module 201 may start a new crawl iteration and/or one or more relevance determination models may be updated at a certain time interval and/or whenever certain changes (and/or updates) are detected in the user interaction data related to the determined interaction profile (e.g., adding, removing, and/or modifying the positive and/or negative content in the user interaction data). In some embodiments, content crawling module 201 and/or trainer module 205 may periodically ping user interaction database 136 (not shown in FIG. 2) to check if the user has made any change to the database by adding, removing, and/or modifying the positive and/or negative content (e.g., by adding notes to a content item during user-initiated searches, un-tagging a content item in the user content list, etc.). If no changes are detected, the crawling process and/or training process may not be triggered. In other embodiments, content crawling module 201 and/or trainer module 205 may continuously monitor user interaction database 136 to detect any changes such that the crawling process and/or training process may be immediately triggered upon the detection. This ability to continuously crawl for new content and/or update the relevance determination model based on the user interaction data may enable the system to update the recommended content list in real-time as the user interacts with content found during user-initiated searches and/or add content to the user content list from the recommended content list, and/or edit and/or remove content from the user content list. That is, the user may immediately see the changes in the ranking for the recommended content list as soon as the user bookmarks a webpage while browsing the Internet, for example. In some embodiments, newly updated relevance scores and/or newly updated color indicators (e.g., Green=relevant, Yellow=ambiguous, Red=non-relevant, etc.) corresponding to individual content items in the newly updated recommended content list may be presented to the user via user interface module 116.

In some embodiments, trainer module 205 may be configured to update the one or more existing relevance determination models based on the user interaction data through an iterative training and re-training process. After categorizing the user's interactions into positive and negative content (as discussed herein with respect to user interaction module 204), the training procedures may be triggered. For example, trainer module 205 may analyze and/or compare the content (e.g., textual content, links, etc.) of these two sets to create an updated relevance determination model.

Various classification algorithms as apparent to those skilled in the art may be used to create an initial relevance determination model and/or an updated model. For example, classification algorithms may be based on a machine learning approach, a semantic approach (word meaning-based approaches that depend on dictionaries or word lists), or a hybrid approach combining the semantic and machine learning approaches. While a machine learning approach (e.g., which may, for example, focus on finding patterns of words and of sets of words or of other attributes or features of a document) does not depend on the meaning of individual words, semantic approaches may classify documents by finding a link between keywords or semantic concepts (e.g., places, people, etc.) (that may be extracted from the documents and from metadata related to the documents) and known keywords and concepts that may also be hierarchically represented in structures of meaning (e.g., ontologies). The known keywords and concepts may be found in the Linked Web of Data, DBpedia, Wikipedia, and the like, or in proprietary schemas or ontologies created by users of the system or by other parties. They can also be automatically extracted from documents and/or provided by user input (e.g., user-defined tags). For example, based on a semantic approach, content in the recommended content lists, user interaction data (e.g., user content lists, user-provided content lists, etc.), crawled content, and/or other seed content may be linked to and/or classified by the known keywords and concepts defined in ontologies.

In some embodiments, by combining probabilistic (machine learning) and structural (semantic) approaches to build a hybrid classification method, an ontology for each topic (not just for keywords) may be built using hierarchical online clustering. Rather than just an ontology of words, an ontology may be created from documents, for example by clustering documents hierarchically by topic and then extracting an ontology from this clustering, on a partly or fully automated basis. Typically, an ontology is created with keywords or phrases. An ontology created from documents, on the other hand, may be created by making clusters of documents or content and then extracting ontology from individual clusters. As such, the hybrid classification method, unlike pure semantic approaches, may build a topic-based ontology automatically or with minimal human input.

In some embodiments, the system may automatically generate an ontology based on user input (e.g., user-defined tags), the extraction of keywords or semantic concepts from the text of documents or metadata, and/or the known concepts found in the Linked Web of Data, DBPedia, Wikipedia, and the like, or in other proprietary schemas or ontologies created by users of the system or by other parties. For example, an ontology may be created based on frequently-occurring terms or entities, or sets of terms or entities, within recommended documents or from direct user input. Ontologies can then be used either for text enhancement of displayed results (e.g., by providing hyperlinks to Linked Web of Data content corresponding to specific entities) or to provide another strategy for classifying and determining the relevance of newly discovered or crawled documents, which may be referred to as a hybrid (probabilistic-semantic) relevance classification approach.

Newly updated models may be maintained and/or stored in a relevance models database 138 and/or other database.

In some embodiments, interaction profiles and/or user interaction data that are inputted into trainer module 205 and/or content crawling module 201 and/or other seed content maintained by seed content database 134 may be also drawn from other external services, tools, and/or systems. For example, they may be drawn from user contact lists by integrating with a database or data warehouse, a CRM system, and/or an enterprise resource planning (ERP) system.

In some embodiments, the system may be integrated with other external services, tools, and/or systems for processing, disseminating, archiving, and/or sharing outputs (e.g., reports, research results, etc.) of the system. Those external services, tools, and/or systems may include, for example, business intelligence systems, business analytics software or tools, word processing software or tools, graphical presentation software or tools, spreadsheet software or tools, a wiki, and/or other database.

In some embodiments, the system may be implemented with cybersecurity principles and technologies to protect the system and the components within the system from unintended or unauthorized access, change, and/or destruction, ensuring a high level of privacy, security, and anonymity of the projects, users, and content. This may, for example, include anonymizing searches, activities, and other user interactions of users.

In some embodiments, content (including recommended content lists, user content lists, etc.) may be shared across users, teams, and/or projects. Content may be publicly shared with one or more subscribers to the system and/or published on the web.

In some embodiments, computer 110 may be configured to manage redundancy in content by clustering and/or grouping all of the replicated content together. For example, grouping similar documents from the web together would allow users to avoid reviewing all of them separately. Once one version of a document is found from the web, computer 110 may gather all of other replicated (e.g., exact or similar) versions of the document. For example, the same news article may be replicated hundreds of times across the web by different news organizations or blogs. In addition, when a user finds or adds another version of an article that has already been discovered and/or stored by the system, this new version may then be clustered with the other copies in a single multi-document group.

In some embodiments, a title of a research topic defined by a user including keywords and synonyms thereof may be used as seed content for iterative crawling and/or training the relevance determination models.

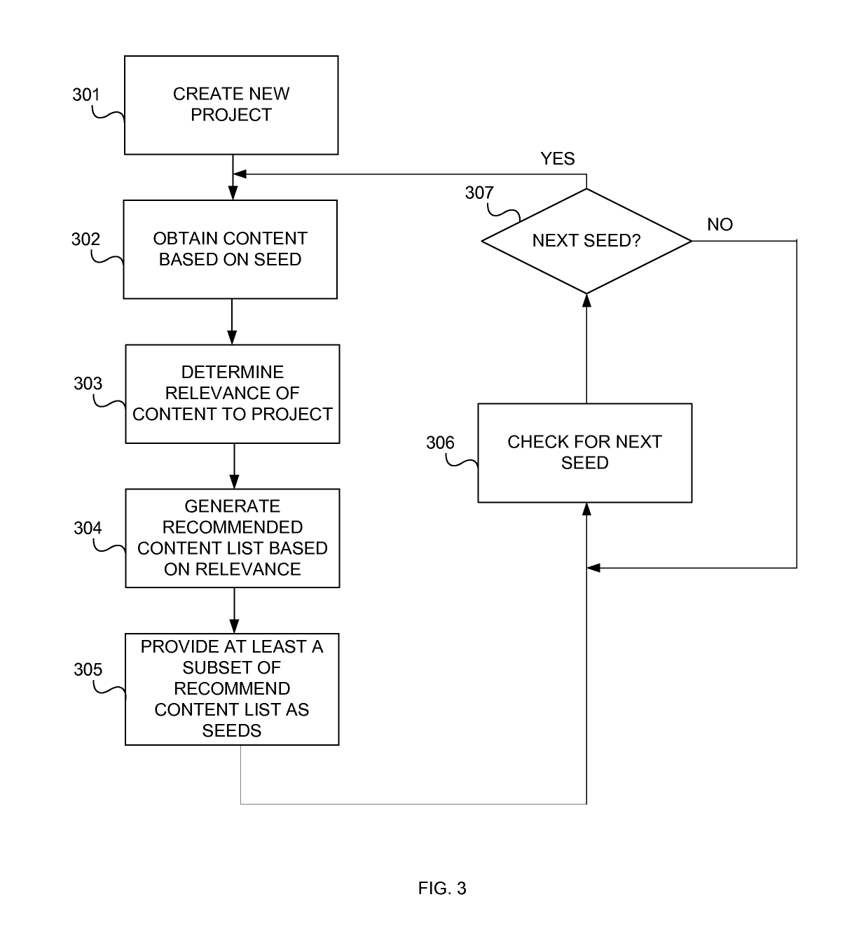

FIG. 3 illustrates a process 300 of crawling for content based on seed content, according to an aspect of the invention. The various processing operations and/or data flows depicted in FIG. 3 (and in the other drawing figures) are described in greater detail herein. The described operations may be accomplished using some or all of the system components described in detail above and, in some embodiments, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

Referring to FIG. 3, in an operation 301, process 300 may include creating a new project. For example, a user may create a new project by specifying a title and/or one or more topics related to the project, specifying a team lead for the project, selecting one or more users as members of the project team, etc.

In an operation 302, process 300 may include obtaining content based on one or more crawl seeds. The seed content may comprise, for example, a list of sample of Universal Resource Locators (URLs), user interaction data, recommended content, and/or other content. For example, content crawler module 201 may initially use the list of sample of URLs to request content from one or more content sources in which the URLs may be located.

In an operation 303, process 300 may include determining relevance of obtained content to the project based on one or more relevance determination models. In an operation 304, process 300 may include generating a recommended content list based on the determined relevance. For example, the content may be ranked by the relevance score assigned for each content item. The recommended content list may be generated based on the ranking. In another example, the relevance score assigned for each content item may be compared to a predetermined threshold (e.g., system generated and/or user-specified). The recommended content list may include content items that are associated with relevance scores above (and/or equal to) the threshold and/or exclude content items that are associated with relevance scores below (and/or equal to) the threshold.

In an operation 305, process 300 may include providing at least a subset of a recommended content list as new seeds for the next iteration of crawling. For example, the subset may include the top N content items from the recommended content list. In another example, the entire set of recommended content may be provided. The subset and/or entire set of recommended content list may be stored in seed content database 134 from which content crawler module 201 may extract and/or retrieve seeds for the next iteration of crawling.

In an operation 306, process 300 may include checking for new seeds to use for the next iteration of crawling. In one example, process 300 may check seed content database 134 to retrieve seeds that have been newly added to the database. In another example, process 300 may check to see if there have been any changes and/or updates detected in the user interaction database. In an operation 307, process 300 may determine whether there is a content item and/or a set of content items that may be used as seeds for the next iteration of crawling. If it is determined that there is, process 300 may return to operation 302 to obtain additional content based on the new seeds. If, on the other hand, there are no new seeds available, process 300 may return to operation 306 to check for new seeds from various seed sources (e.g., user interaction data, recommended content list, etc.).

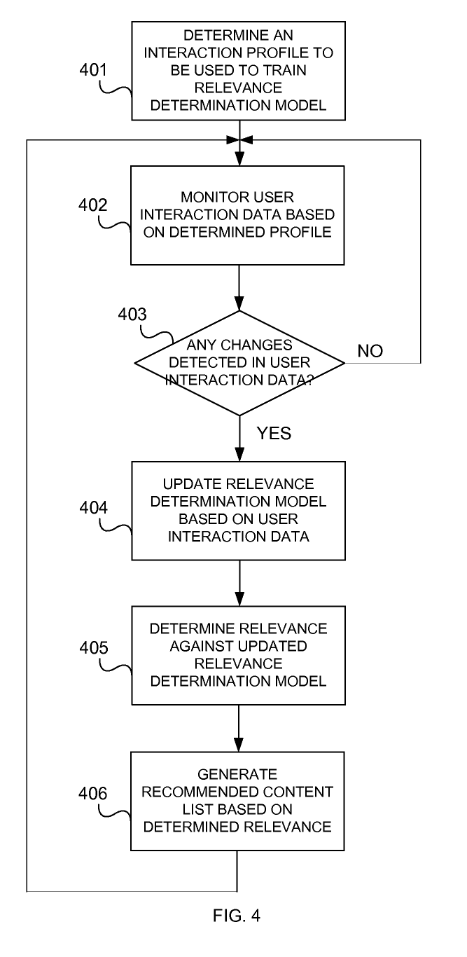

FIG. 4 illustrates a process 400 of training one or more relevance determination models based on an interaction profile, according to an aspect of the invention.

In an operation 401, process 400 may include determining an interaction profile to be used to update one or more relevance determination models associated with a particular user-project combination. For example, a user may be aware of the fact that one of her teammates is a skilled researcher. In that case, the user may want to select a team-based profile that is created based on the user-based profile of that teammate. As such, the interaction of a senior researcher may be weighted more highly than that of other junior researchers when determining the relevance.

In an operation 402, process 400 may include monitoring the user interaction data based on the determined profile. When the team-based profile has been selected by the user, process 400 may monitor the user interaction data of the user and the teammate specified in the team-based profile. In an operation 403, process 400 may determine whether certain changes (and/or updates) are detected in the user interaction data related to the determined interaction profile. The detectable changes and/updates may include adding, removing, and/or modifying the positive and/or negative content in the user interaction data, for example. If process 400 determines that no changes and/or updates have been made, process 400 may return to operation 402 to continue the monitoring. Until a change in the user interaction data is detected, the training process may not be triggered. On the other hand, if process 400 determines that a change and/or update has been made to the user interaction data, process 400 may proceed to an operation 404 to update the one or more existing relevance determination models based on the user interaction data related to the determined interaction profile.

In an operation 405, process 400 may include determining the relevance of content obtained by content crawler module 201 (e.g., newly obtained based on the change/update detected in the user interaction data and/or previously obtained during the previous iteration of crawl) against the updated one or more relevance determination models.

In an operation 406, process 400 may include generating a recommended content list based on the relevance determined based on the updated relevance determination model.

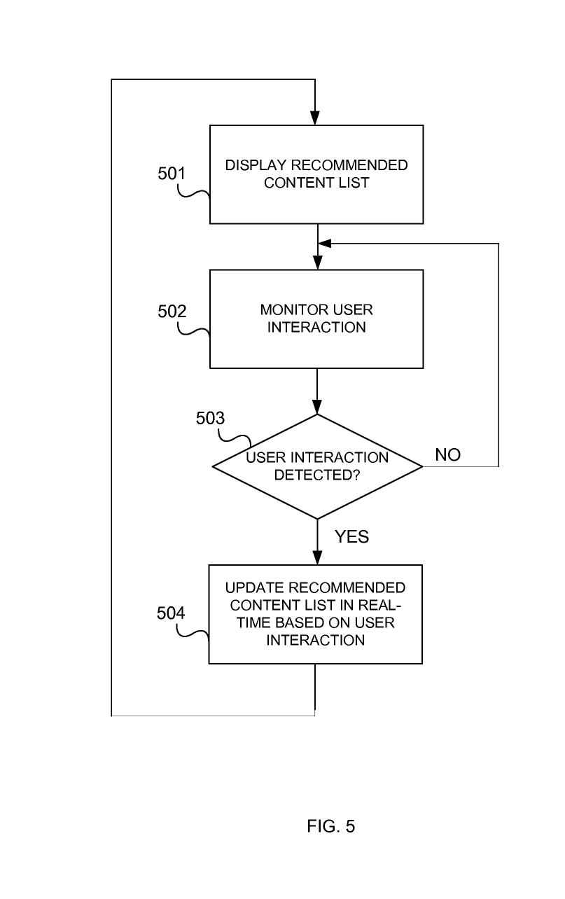

FIG. 5 illustrates a process 500 of updating a recommended content list in real-time as a user interacts with content, according to an aspect of the invention.

In an operation 501, process 500 may include displaying a recommended content list via a user interface. Process 500 may monitor user activities, behaviors, and/or other user interactions during user-initiated searches and/or the user's interactions with the recommended content list. For example, the user interaction data related to webpages the user visited, the documents the user viewed or opened, and/or other content items the user tagged, bookmarked, added annotations, comments, and/or notes to may be monitored and/or logged.

In an operation 502, process 500 may include determining whether any positive and/or negative signals have been detected during the monitoring. If it is determined that one or more of positive and/or negative signals have been detected, process 500 may proceed to an operation 504. In operation 504, process 500 may update the recommended content list in real-time based on the detected user interaction. The recommended content list may be updated in real-time as the user interacts with content found during user-initiated searches and/or adds content to the user content list from the recommended content list, and/or edits and/or removes content from the user content list. That is, the user may immediately see the changes in the ranking for the recommended content list as soon as the user bookmarks a webpage while browsing the Internet, for example.

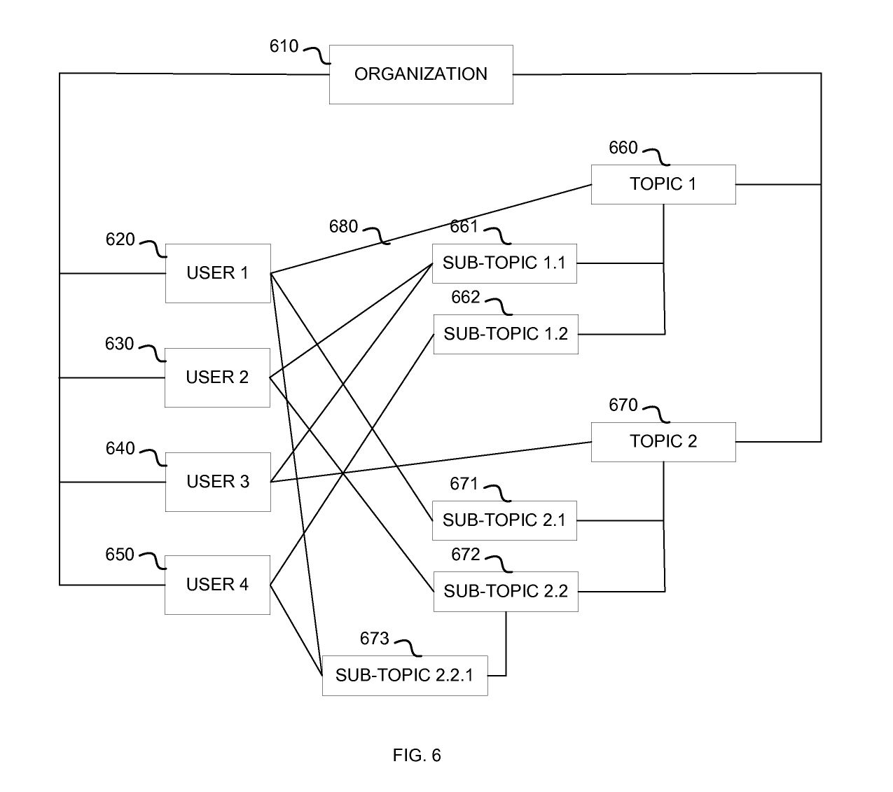

FIG. 6 illustrates a data structure 600 in which an exemplary mapping between a user and one or more projects is shown, according to an aspect of the invention.

Data structure 600 may include an organization node 610 that may represent a company, employer, research firm, and/or other organization to which one or more users belong. Organization node 610 may be associated with one or more organization attributes including an organization name, type of organization, size of organization (e.g., the number of employees), and/or other attributes. User nodes 620, 630, 640, and 650 may represent User 1, User 2, User 3, and User 4 who may be working for the organization that may be represented by organization node 610. A user node may be associated with one or more user attributes including user ID, user name, title, office phone, cell phone, address, and/or other information related to the user.

Data structure 600 may include topic nodes 660, 661, 662, 670, 671, 672, and 673. Each of topic nodes 660, 661, 662, 670, 671, 672, and 673 may represent a project. In some embodiments, the research project related to research Topic 1 (illustrated as topic node 660) may be also related to research Sub-Topic 1.1 (illustrated as topic node 661) and Sub-Topic 1.2 (illustrated as topic node 662) based on the hierarchical relationship between Topic 1 and two sub-topics within Topic 1. In these embodiments, User 1 may be within the same project team (as illustrated as topic node 661) as User 2 and User 3. User 1 and User 4 may become teammates for the project related to Sub-Topic 1.2. In other embodiments, the hierarchical relationship between topics and sub-topics may be ignored and User 1 and User 4 may not be considered as teammates, for example. Individual links (e.g., link 680) between user nodes and topic nodes may represent a particular user-project combination.

In some embodiments, relevance determination models, user content lists, recommended content lists, user-based interaction profiles, team-based interaction profiles, and/or other information associated with a particular project (e.g., Sub-Topic 2.1) may, at the discretion of user(s), be merged with the respective ones associated with one or more other projects (e.g., Topic 1, Sub-Topic 1.1, Sub-Topic 1.2, Sub-Topic 2.2, Sub-Topic 2.2.1). In some embodiments, relevance determination models, user content lists, recommended content lists, user-based interaction profiles, team-based interaction profiles, and/or other information associated with one or more Sub-Topics (e.g., Sub-Topic 2.1, Sub-Topic 2.2, and Sub-Topic 2.2.1) may, at the discretion of user(s), be merged together under the main topic (e.g., Topic 2).

In some embodiments, relevance determination models, user content lists, recommended content lists, user-based interaction profiles, and/or other information may be associated with a single user and may be merged with the respective ones associated with one or more teammates for a particular project.

FIG. 7 illustrates a screenshot of an interface 700 for managing a recommended content list, according to an aspect of the invention. The screenshots illustrated in FIG. 7 and other drawing figures are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting.

Referring to FIG. 7, interface 700 may include menu tabs 710 and 720 which may be used to switch back and forth between a recommended content list (illustrated as menu tab 710) and a user content list (illustrated as menu tab 720). Menu tab 710 illustrated in solid line may indicate that the user is currently viewing the recommended content list. The user may switch the active display to the user content list by selecting and/or pressing menu tab 720 (illustrated in dotted line).

Interface 700 may include recommended content items 730, 740, 750, and 760. The relevance score assigned to each of the recommended content items may be indicated by score display element 731, 741, 751, and 761. In some embodiments, the relevance score may be converted into a corresponding color code which may reflect the level of relevance (e.g., Green for very likely to be relevant to the topic currently being researched, Yellow for not likely to be relevant or irrelevant, Red for very unlikely to be relevant, etc.). Although not illustrated, a color indicator with an appropriate color code may be displayed via interface 700. In some embodiments, recommended content items may be itemized, labelled, displayed, or otherwise associated with corresponding content sources or content source types (e.g., blog, news site, Twitter, etc.).

Interface 700 may include a summary section (illustrated as summary elements 733, 743, 753, and 763) for each recommended content item. The summary section may include information related to a corresponding recommended content item such as the title of content item, URL, the introduction which may provide a concise description of the content, and/or other information.

A recommended content item may be added to the user content list (and/or removed from the recommended content list) by pressing, clicking on, or otherwise selecting an “ADD” element (illustrated as “ADD” elements 732, 742, 752, and 762). For example, when “ADD” element 732 is selected, recommended content item 730 may be added to the user content list. In another example, recommended content item 730 may be added by dragging and dropping recommended content item 730 onto a drag and drop box 770.

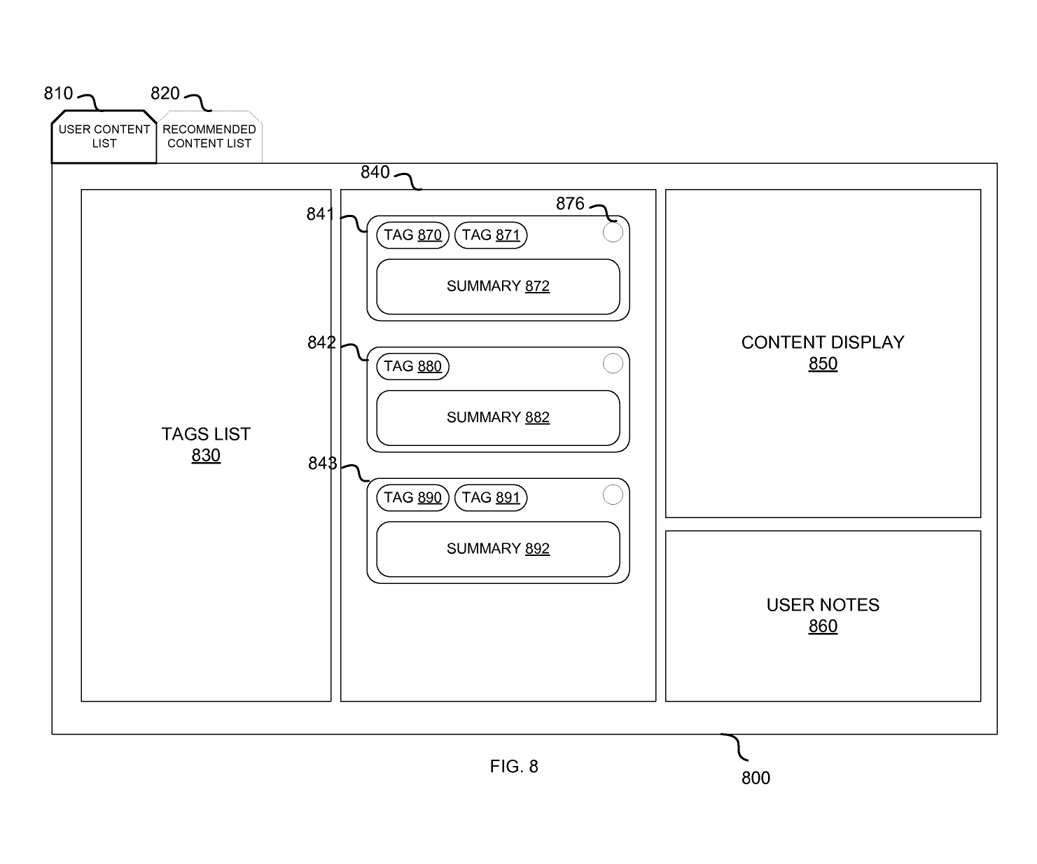

FIG. 8 illustrates a screenshot of an interface 800 for managing a user content list, according to an aspect of the invention.

Interface 800 may include menu tabs 810 and 820 which may be used to switch back and forth between a user content list (illustrated as menu tab 810) and a recommended content list (illustrated as menu tab 820). Menu tab 810 illustrated in solid line may indicate that the user is currently viewing the user content list. The user may switch the active display to the recommended content list by selecting and/or pressing menu tab 820 (illustrated in dotted line).

Interface 800 may include “Tags List” window pane 830 which may display one or more tags associated with at least one of the content items included in the user content list. These tags may be used to search for one or more content items within the user content list. The tags may be shown in alphabetical order (or reverse alphabetical order) and/or in any other order. The tags may be grouped automatically by clustering and/or classified into different groups in part based on input by human evaluators. Tags may be searched by one or more keywords that may be included in the text of tags. A user may filter content items by selecting and/or de-selecting the tags. Search operators such as AND, OR, NOT, XOR, etc. may be used in conjunction with tags. In some embodiments, only the content items included in the user content list may be associated with one or more tags. In some embodiments, a hierarchy may be used for the tags such that a single tag may consist of one or more tags. For example, the tag “U.S.A.” may contain a plurality of other tags indicating different states in the United States and each tag corresponding to a state may contain tags related to cities, etc. These represent at least three levels of hierarchy. When a user adds a tag to a document, for example, “Los Angeles,” the tags “California” and “U.S.A.” may be automatically considered for that document. On the other hand, an ontology and/or dictionary may be used to associate tags with each other. For instance, the tag “Deutschland,” “Germany,” “Saksa,” “Almaniya,” may be considered the same as those terms are referring to the same concept but in different languages.

Interface 800 may include “Document List” window pane 840 which may display one or more user content items (illustrated as user content items 841, 842, and 843). Interface 800 may include tags elements 870, 871, 880, 890, and 891. A user may add a new tag to user content item 841 by clicking on or otherwise selecting an “Add Tag” element 876. A new tag is added using “Add Tag” element 876, the new tag may appear next to the current tags associated with user content item 841 (illustrated as tags 870 and 871). An existing tag may be removed by clicking or otherwise selecting a remove button (not illustrated) appearing near or inside the tag.

Interface 800 may include a summary section (illustrated as summary elements 872, 882, and 892) for each user content item. The summary section may include information related to a corresponding user content item such as the title of content item, URL, the introduction which may provide a concise description of the content, star (e.g., indicating the level of importance associated with the content item), favorite (e.g., indicating whether the content item is designated as a favorite content item), and/or other information. A content item may be removed from the user content list by clicking on or otherwise selecting a remove button (not illustrated) appearing near or inside the content item.

Interface 800 may include a content display window pane 850. Content of a selected user content item may be displayed within content display window pane 850. The content may be viewed in a textual content view and/or a web view. When a user adds a document to the user content list by bookmarking, adding from the recommended content list, or any other means, the textual content of the document may be extracted and added as a feature to the document. The textual content of the content may be displayed via the textual content view. When a document is shown in the textual content view, the text of the document may be analyzed for the entity recognition. Entity recognition may search for the entities in the document such as names of places, people, geographical locations, terms and expressions, scientific terms, and/or other entities. User-defined entity recognition may be used to link the terms found in the content of the document to similar documents which have been added by the user. In the web view, the actual webpage of the document may be displayed. Under the textual content view and/or web view, the user may add manual notes to each document. This feature may give the possibility to the user to enter more feedback about the document. The user may also add styling to the text (e.g., aligning the text to left, right, or center, creating a new paragraph, making the text or a part of the text bold, italic, or underlined, adding bullet points or numbering, highlighting or un-highlighting, etc.).

Interface may include a user notes area 860. The user may add detailed notes in this section. The user may also add styling to the notes (e.g., aligning the text to left, right, or center, creating a new paragraph, making the text or a part of the text bold, italic, or underlined, adding bullet points or numbering, highlighting or un-highlighting, etc.). For example, the user can first highlight a part of the text in the textual content view, read the actual website and browse other pages in the web view or even navigate to external links and at the same time copy and paste the text in user notes area 860. Then the user can switch to the textual content view and pull in the highlighted text into user notes area 860 and/or format them. Notes added in user notes area 860 may be automatically stored in content database 132 and/or other database.

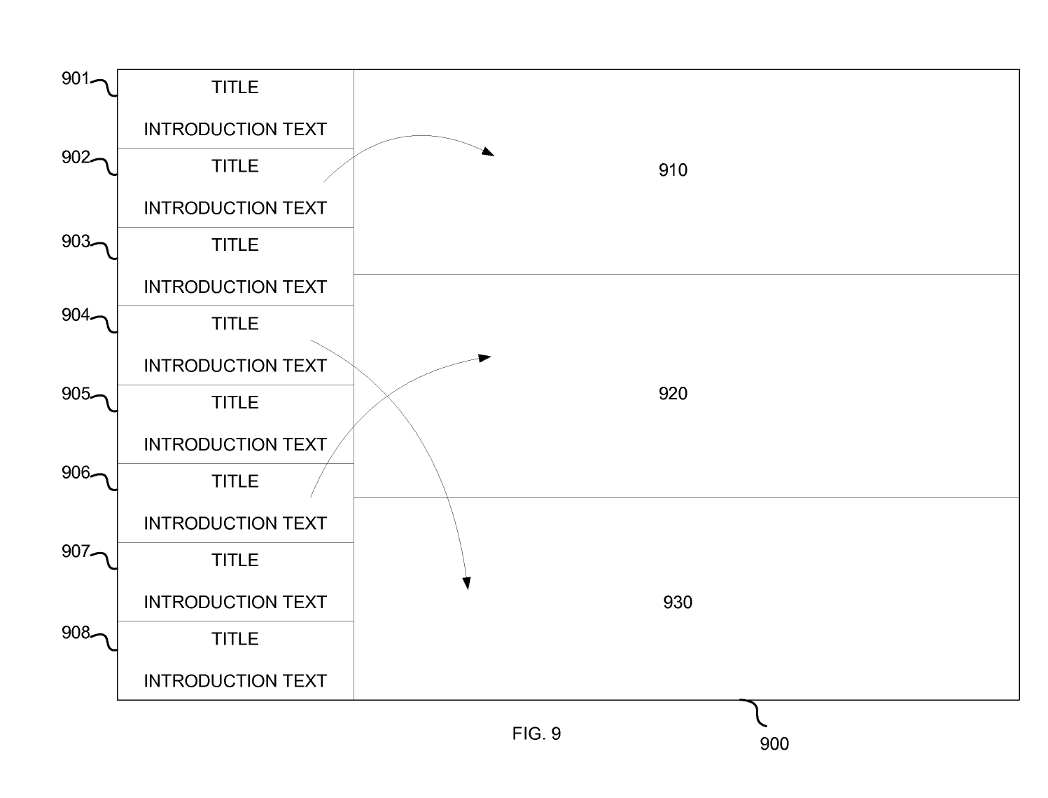

FIG. 9 illustrates a screenshot of an interface 900 for generating a report, according to an aspect of the invention.

Interface 900 may include notes elements 901, 902, 903, 904, 905, 906, 907, and 908, which may be used to create a report. Each note element may show the title, introduction text, and/or other information of the document to which the note element corresponds. The user may drag and drop the notes elements to change the order of the notes corresponding to each of the documents. For example, note element 902 may be dragged and dropped onto a first section 910, note element 906 may be dragged and dropped onto a second section 920, and note element 904 may be dragged and dropped onto a third section 930.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer implemented method for iteratively obtaining content related to a project, the method being implemented in a computer system having one or more physical processors programmed with computer program instructions that, when executed by the one or more physical processors, cause the computer system to perform the method, the method comprising:
creating a project;
associating a project team comprising one or more users with the project;
identifying initial seed content containing information known to be relevant to the project;
developing a classification model based on the seed content information;
obtaining a first set of additional content items;
determining relevance of the first set of additional content items to the project based on the classification model;
generating a recommended content list;
storing the recommended content list for display to a user;
monitoring user interaction in connection with the project;
updating the classification model based on the user interaction;
obtaining a second set of additional content items; and
determining the relevance of the second set of additional content items to the project based on the classification model.

2. The method of claim 1, wherein obtaining the first set of additional content items further comprises:
crawling one or more content sources based on the seed content information; and
obtaining, from the one or more content sources, the first set of additional content items.

3. The method of claim 1, wherein the first set of additional content items comprises content provided by at least one of the one or more users.

4. The method of claim 1, wherein determining relevance of the first set of additional content items to the project based on the classification model further comprises:
selecting the classification model among a plurality of classification models based on identification of the user and identification of the project.

5. The method of claim 1, wherein determining relevance of the first set of additional content items to the project based on the classification model further comprises:
determining, by the classification model, a relevance score for individual content items of the first set of additional content items based on one or more relevance factors, wherein the one or more relevance factors comprise relevance between the individual content items and one or more tags assigned to the project and/or the type of content source that provided the individual content items.

6. The method of claim 5, wherein generating the recommended content list further comprises:
ranking the first set of additional content items by the relevance score associated with the individual content items;
selecting a subset of the first set of additional content items based on the ranking; and
including the subset of the first set of additional content items in the recommended content list.

7. The method of claim 1, wherein the user interaction comprises one or more user's positive and/or negative interactions with at least one content item included in the recommended content list.

8. The method of claim 1, wherein obtaining the second set of additional content items further comprises:
crawling one or more content sources based in part on the recommended content list and information related to the user interaction; and
obtaining, from the one or more content sources, the second set of additional content items.

9. The method of claim 8, further comprising:
determining relevance of the second set of additional content items to the project based on the classification model;
updating the recommended content list;
storing the recommended content list for display to the user;
monitoring the user interaction in connection with the project;
updating the classification model based on the user interaction;
obtaining a third set of additional content items; and
determining the relevance of the third set of additional content items based on the classification model.

10. The method of claim 1, further comprising:
determining, in real-time, the relevance of a content item that the user is currently accessing or viewing via a user interface; and
communicating the relevance of the content item to the user via the user interface.

11. A computer implemented method for training classification models based on user interaction data, the user interaction data comprising one or more users' positive and/or negative interactions with content, the method being implemented in a computer system having one or more physical processors programmed with computer program instructions that, when executed by the one or more physical processors, cause the computer system to perform the method, the method comprising:
generating a user-based interaction profile comprising the user interaction data associated with a user of a project;
aggregating a plurality of user-based interaction profiles into a team-based interaction profile;
determining an interaction profile to be used to train a classification model, wherein the interaction profile is the user-based interaction profile or the team-based interaction profile;
monitoring the user interaction data related to the determined interaction profile;
determining when the user interaction data related to the determined interaction profile has been changed;
updating the classification model based on the determination;
determining relevance of one or more content items to the project based on the classification model; and
generating a recommended content list based on the relevance.

12. The method of claim 11, wherein generating the recommended content list based on the relevance further comprises:
crawling one or more content sources based in part on the recommended content list and the user-based and/or team-based interaction profile.
obtaining, from the one or more content sources, a set of additional content items;
determining the relevance of the set of additional content items to the project based on the classification model; and
updating the recommended content list based on the relevance.

13. The method of claim 11, further comprising:
updating the classification model at a predetermined time interval based on the determined interaction profile.

14. The method of claim 11, wherein the user interaction data comprise the user's positive and/or negative interactions with at least one content item included in the recommended content list.

15. A computer implemented method for updating a recommended content list in real-time based on changes in user interaction data, the user interaction data comprising a user's positive and/or negative interactions with content, the method being implemented in a computer system having one or more physical processors programmed with computer program instructions that, when executed by the one or more physical processors, cause the computer system to perform the method, the method comprising:
communicating the recommended content list to a user, the recommended content list comprising one or more content items that have been determined to be relevant to a project that the user is associated with;
monitoring interaction of the user with the one or more content items included in the recommended content list;
determining when the user positively interacted with the one or more content items included in the recommended content list based on the monitoring; and
updating the recommended content list in real-time based on the positive user interaction.

16. The method of claim 15, wherein communicating the recommended content list to the user further comprises:
crawling one or more content sources to obtain a set of content items;
determining a relevance score for individual content items of the set of content items based on one or more relevance factors, wherein the one or more relevance factors comprise relevance between the individual content items and one or more tags assigned to the project and/or the type of content source that provided the individual content items; and
generating the recommended content list.

17. The method of claim 16, wherein generating the recommended content list further comprises:
ranking the set of content items by the relevance score associated with the individual content items;
selecting a subset of the set of content items based on the ranking; and
including the subset of the set of content items in the recommended content list.

18. The method of claim 17, wherein updating the recommended content list in real-time based on the positive user interaction further comprises:
crawling the one or more content sources to obtain a set of additional content items;
determining the relevance score for individual content items of the set of content items and the set of additional content items based on the one or more relevance factors;
ranking the set of content items and the set of additional content items by the relevance score associated with the individual content items; and
updating the recommended content list based on the ranking.

19. The method of claim 15, wherein the positive user interaction comprises adding, by the user, tags, bookmarks, annotations, comments, and/or notes to the one or more content items included in the recommended content list.

20. A system for iteratively obtaining content related to a project, the system comprising:
one or more physical processors programmed with computer program instructions that, when executed by the one or more physical processors, cause the one or more physical processors to:
create a project;
associate a project team comprising one or more users with the project;
identify initial seed content containing information known to be relevant to the project;
develop a classification model based on the seed content information;
obtain a first set of additional content items;
determine relevance of the first set of additional content items to the project based on the classification model;
generate a recommended content list;
store the recommended content list for display to a user;
monitor user interaction in connection with the project;
update the classification model based on the user interaction;
obtain a second set of additional content items; and
determine the relevance of the second set of additional content items to the project based on the classification model.

21. A system for training classification models based on user interaction data, the user interaction data comprising one or more users' positive and/or negative interactions with content, the system comprising:
one or more physical processors programmed with computer program instructions that, when executed by the one or more physical processors, cause the one or more physical processors to:
generate a user-based interaction profile comprising the user interaction data associated with a user of a project;
aggregate a plurality of user-based interaction profiles into a team-based interaction profile;
determine an interaction profile to be used to train a classification model, wherein the interaction profile is the user-based interaction profile or the team-based interaction profile;
monitor the user interaction data related to the determined interaction profile;
determine when the user interaction data related to the determined interaction profile has been changed;
update the classification model based on the determination;
determine relevance of one or more content items to the project based on the classification model; and
generate a recommended content list based on the relevance.

22. A system for updating a recommended content list in real-time based on changes in user interaction data, the user interaction data comprising a user's positive and/or negative interactions with content, the system comprising:
one or more physical processors programmed with computer program instructions that, when executed by the one or more physical processors, cause the one or more physical processors to:
communicate the recommended content list to a user, the recommended content list comprising one or more content items that have been determined to be relevant to a project that the user is associated with;
monitor interaction of the user with the one or more content items included in the recommended content list;
determine when the user positively interacted with the one or more content items included in the recommended content list based on the monitoring; and
update the recommended content list in real-time based on the positive user interaction.
